(19) United States
(12) Patent Application Publication
(10) Pub. No.: US 2025/0349909 A1
(43) Pub. Date: Nov. 13, 2025

(54) BATTERY CELL INCLUDING FUNCTIONALIZED SEPARATOR

(71) Applicant: GM GLOBAL TECHNOLOGY OPERATONS LLC, Detroit, MI (US)

(72) Inventors: Xin ZHANG, Shanghai (CN); Zhe Li, Shanghai (CN); Qili Su, Shanghai (CN); Haijing Liu, Shanghai (CN)

(21) Appl. No.: 18/673,393

(22) Filed: May 24, 2024

(30) Foreign Application Priority Data
May 10, 2024 (CN) 2024105786480

(51) Int. Cl. H01M 10/42; H01M 4/02; H01M 4/131; H01M 4/36; H01M 4/58; H01M 4/62; H01M 50/42; H01M 50/426; H01M 50/431; H01M 50/443; H01M 50/457; H01M 50/46

(52) U.S. Cl. CPC H01M 10/4235; H01M 4/131; H01M 4/366; H01M 4/5825; H01M 4/623; H01M 4/625; H01M 50/42; H01M 50/426; H01M 50/431; H01M 50/443; H01M 50/457; H01M 50/46; H01M 2004/028

(57) ABSTRACT

A battery cell includes C cathode electrodes, A anode electrodes, and S separators, where C, A, and S are integers greater than zero. Each of the S separators includes a separator layer, a first active solid coating layer arranged on the separator layer, and a protective layer.

### CROSS-REFERENCE TO RELATED APPLICATIONS

This application claims the benefit of Chinese Patent Application No. 202410578648.0 filed on May 10, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including a functionalized separator.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes, A anode electrodes, and S separators, where C, A, and S are integers greater than zero. Each of the S separators includes a separator layer, a first active solid coating layer arranged on the separator layer, and a protective layer.

In other features, each of the S separators further includes a second active coating layer. The separator layer is arranged adjacent to one of the C cathode electrodes. The first active solid coating layer is arranged adjacent to the separator layer. The protective layer is arranged between the first active solid coating layer and one of the A anode electrodes.

In other features, the second active coating layer is arranged adjacent to one of the C cathode electrodes. The separator layer is arranged adjacent to the second active coating layer. The first active solid coating layer is arranged adjacent to the separator layer. The protective layer is arranged between the first active solid coating layer and one of the A anode electrodes.

In other features, the first active solid coating layer comprises active solid particles that react with lithium. The active solid particles are selected from a group consisting of Li_{1.3}Al_{0.3}Ti_{1.7}(PO₄)₃ (LATP), Li_{0.33}La_{0.56}TiO₃ (LLTO), Si, Sn, Li₂S—P₂S₅—GeS₂ system, Li_{3.25}Ge_{0.25}P_{0.75}S₄, and Li₁₀GeP₂S₁₂. The active solid particles have a particle size in a range from 10 nm to 1000 nm.

In other features, the first active solid coating layer has a thickness in a range from 1 μm to 10 μm. The protective layer comprises a polymer selected from a group consisting of polyvinylidene difluoride (PVDF), poly(methyl methacrylate) (PMMA), poly(ethylene oxide) (PEO). The protective layer has a thickness in a range from 1 μm to 5 μm.

In other features, the separator layer is selected from a group consisting of a polyolefin-based separator layer, a cellulose separator layer, a polyvinylidene fluoride (PVDF) layer, and a porous polyimide layer. The separator layer has a thickness in a range from 6 μm to 25 μm.

In other features, the A anode electrodes include anode active material selected from a group consisting of metallic lithium and lithium metal composites. The C cathode electrodes comprise cathode active material in a range from 30 to 98 wt %. The cathode active material is selected from a group consisting of a layered oxide, an olivine-type oxide, a monoclinic-type oxide, a spinel-type oxide, sulfide (S), and lithium sulfide (Li2S), where M is a transition metal.

In other features, the C cathode electrodes further comprise at least one of a conductive additive in a range from 1 to 30 wt %, wherein the conductive additive is selected from a group consisting of carbon black, graphite, graphene, graphene oxide, Super P, acetylene black, carbon nanofibers, carbon nanotubes and other electronically conductive additives; and a binder in a range from 1 to 20 wt %, wherein the binder is selected from a group consisting of poly(vinylidene fluoride) (PVDF), poly(vinylidenefluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

A battery cell includes C cathode electrodes, A anode electrodes including anode active material selected from a group consisting of metallic lithium and lithium metal composites, and S separators, where C, A, and S are integers greater than zero. Each of the S separators includes a separator layer, a first active solid coating layer arranged on the separator layer and including active solid particles selected from a group consisting of Li_{1.3}Al_{0.3}Ti_{1.7}(PO₄)₃ (LATP), Li_{0.33}La_{0.56}TiO₃ (LLTO), Si, Sn, Li₂S—P₂S₅—GeS₂ system, Li_{3.25}Ge_{0.25}P_{0.75}S₄, and Li₁₀GeP₂S₁₂, and a protective layer arranged on the first active solid coating layer.

In other features, each of the S separators further includes a second active solid coating layer arranged between the separator layer and one of the C cathode electrodes. The active solid particles have a particle size in a range from 10 nm to 1000 nm. The first active solid coating layer has a thickness in a range from 1 μm to 10 μm. The protective layer comprises a polymer selected from a group consisting of polyvinylidene difluoride (PVDF), poly(methyl methacrylate) (PMMA), poly(ethylene oxide) (PEO). The protective layer has a thickness in a range from 1 μm to 5 μm.

In other features, the separator layer is selected from a group consisting of a polyolefin-based separator layer, a cellulose separator layer, a polyvinylidene fluoride (PVDF) layer, and a porous polyimide layer. The separator layer has a thickness in a range from 6 μm to 25 μm.

In other features, the C cathode electrodes comprise cathode active material in a range from 30 to 98 wt %. The cathode active material is selected from a group consisting of a layered oxide, an olivine-type oxide, a monoclinic-type oxide, a spinel-type oxide, sulfide (S), and lithium sulfide (Li2S), where M is a transition metal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross section of an example of a battery cell including anode electrodes, cathode electrodes, and functionalized separators according to the present disclosure;

FIG. 2 is an enlarged side cross section of an example of the battery cell including a functionalized separator according to the present disclosure;

FIG. 3 illustrates an example of the active solid coating layer of the functionalized separator reacting with lithium dendrites according to the present disclosure;

FIG. 4 is a side cross section of an example of the battery cell including an anode electrode including a functionalized separator with first and second active solid coating layers according to the present disclosure;

FIG. 5 is an energy dispersive spectroscopy elemental mapping of the active solid coating layer of the functionalized separator according to the present disclosure;

FIG. 6 is a graph illustrating an X-ray diffraction pattern for the active solid coating layer of the functionalized separator according to the present disclosure; and

FIG. 7 is a graph illustrating electrochemical performance (voltage as a function of time) for example battery cells including a conventional separator and a functionalized separator according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Lithium is the most promising anode active material for next-generation rechargeable batteries. Lithium has a high theoretical specific capacity (3860 mAh/g), low density (0.534 g/cm³), and low electrochemical potential (−3.040 V vs. SHE). However, uneven striping/plating of lithium during operation is a big issue for rechargeable Li metal battery cells. When the battery cell is operating at high charging current, lithium dendrites form at the lithium anode electrode and grow in the direction of the separator and the cathode electrode. In some situations, the lithium dendrites may penetrate the separator and contact the cathode electrode causing short circuits of the battery cell.

A functionalized separator according to the present disclosure includes a raw separator layer, an active solid coating layer arranged on one side of the separator layer, and a protective layer arranged on the active solid coating layer. The protective layer increases the mechanical strength of the separator to reduce the penetration of Li dendrites into the separator layer and/or cathode electrode.

If the lithium dendrites are able to penetrate the protective layer, the active solid coating layer reacts with the lithium dendrites to eliminate and/or break down Li dendrites. As a result, the functionalized separator makes the lithium metal battery less prone to short circuits under high current density and enhances the cycling performance of the lithium metal battery.

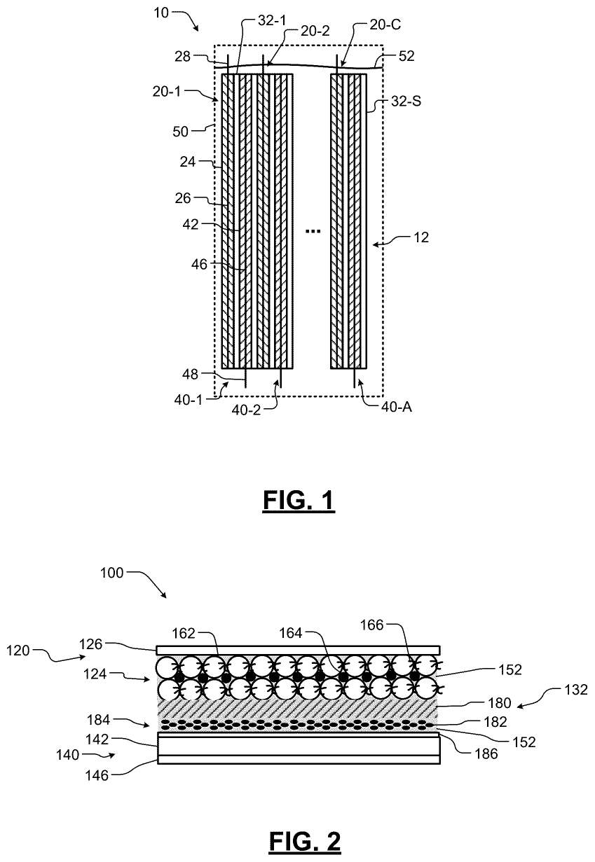

Referring now to FIG. 1, a battery cell 10 includes C cathode electrodes 20, A anode electrodes 40, and S functionalized separators 32 arranged in a predetermined sequence in a battery cell stack 12, where C, S and A are integers greater than zero. The battery cell stack 12 is arranged in an enclosure 50 that includes liquid electrolyte 52. The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46.

During charging/discharging, the A anode electrodes 40 and the C cathode electrodes 20 exchange lithium ions. In some examples, the cathode active material layers 24 comprise coatings including one or more cathode active materials, one or more conductive additives, and/or one or more binder materials that are applied to the current collectors.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIG. 2, a battery cell 100 includes a cathode electrode 120, a functionalized separator 132, an anode electrode 140, and liquid electrolyte 152. The cathode electrode 120 includes cathode active material 162, an optional conductive filler 164, and an optional binder 166. The anode electrode 140 includes an anode active material layer 142 and an anode current collector 146. In some examples, the anode active material layer 142 includes a lithium metal layer. The functionalized separator 132 includes a separator layer 180, an active solid coating layer 184, and a protective layer 186. The active solid coating layer 184 includes active solid particles 182 that react with lithium dendrites 199 that pierce the protective layer 186.

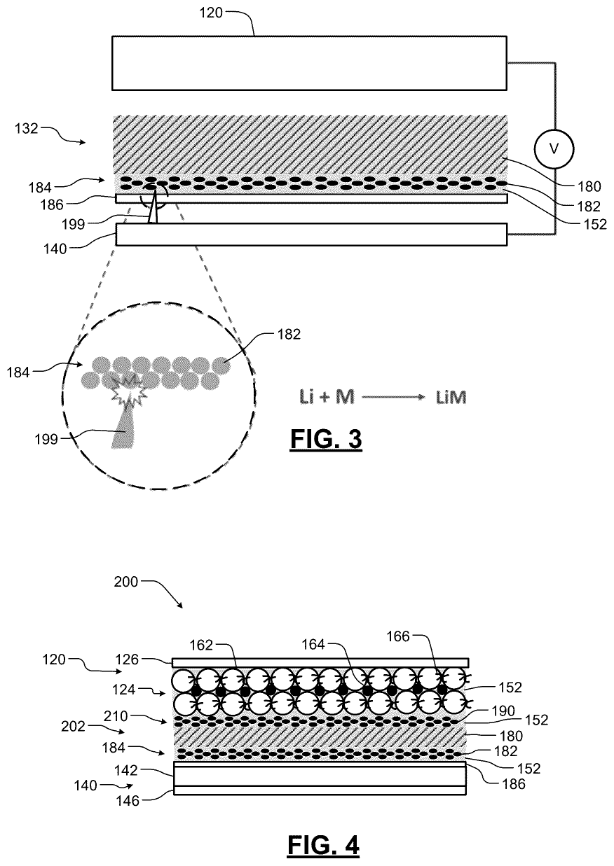

Referring now to FIG. 3, the active solid coating layer 184 reacts with the lithium dendrites when the lithium dendrites penetrate the protective layer 186 and contact the active solid coating layer 184. The lithium reacts with the active solid particles 182 to prevent further lithium dendrite growth and to form one or more other compounds (e.g., some or all may be insulator materials). For example only, Li_{1.3}Al_{0.3}Ti_{1.7}(PO₄)₃ reacts with lithium to form TisP, TiAl, LisP, and Li₂O.

Referring now to FIG. 4, a functionalized separator 202 of another battery cell 200 further includes an active solid coating layer 210 arranged between the functionalized separator 202 and the cathode electrode 120. A protective layer is not arranged between the functionalized separator 202 and the cathode electrode 120.

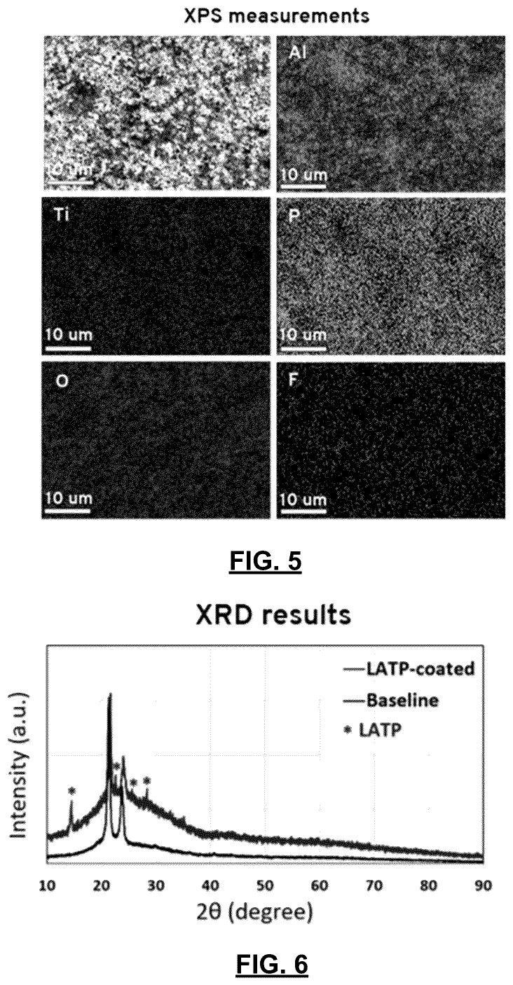

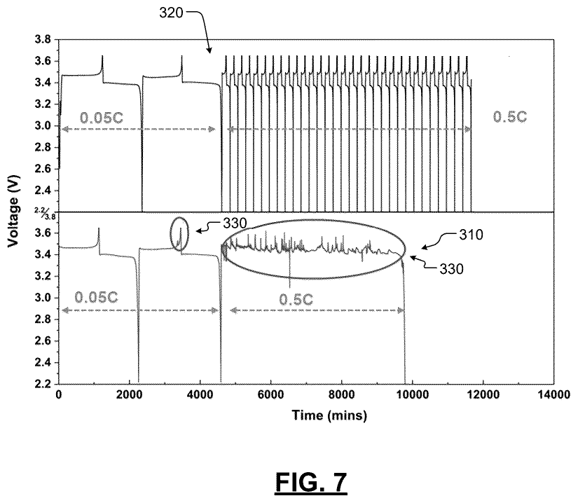

Referring now to FIGS. 5 and 6, details relating to an example functionalized separator including LATP as the active solid coating layer is shown. In FIG. 5, an energy dispersive spectroscopy elemental mapping of the active solid coating layer of the functionalized separator is shown. In FIG. 6, an X-ray diffraction pattern for the active solid coating layer of the functionalized separator. The active solid coating layer can be successfully introduced into the functionalized separator and is homogenously dispersed on the separator layer.

Referring now to FIG. 7, electrochemical performance (voltage as a function of time) is shown for example battery cells including a conventional separator at 310 and a functionalized separator at 320. As can be seen at 330, the battery cell including a conventional separator experiences short circuits and unstable performance while the battery cell with the functional separator does not.

In some examples, the active solid coating layer comprises active solid particles that can react with lithium. In some examples, the solid particles are selected from a group consisting of Li_{1.3}Al_{0.3}Ti_{1.7}(PO₄)₃ (LATP), Li_{0.33}La_{0.56}TiO₃ (LLTO), Si, Sn, Li₂S—P₂S₅—GeS₂ system, and (Li_{3.25}Ge_{0.25}P_{0.75}S₄ and Li₁₀GeP₂S₁₂)). In some examples, the active particles are not soluble in the liquid electrolyte. In some examples, the particle size of the active particles is in a range from 10 nm to 1000 nm. In some examples, the active particles are coated onto the separator layer using spraying technology or a tape casting method. In some examples, the active solid coating layer has a thickness in a range from 1 μm to 10 μm. In some examples, the active solid coating layer comprises LATP having a thickness in a range from 2 μm to 4 μm (e.g., 3 μm).

In some examples, the protective layer reduces or prevents direct contact between the lithium dendrites and the active solid coating layer. In some examples, the protective layer includes a polymer layer. In some examples, the polymer layer is selected from a group consisting of polyvinylidene difluoride (PVDF), poly(methyl methacrylate) (PMMA), poly(ethylene oxide) (PEO). In some examples, the protective layer is coated by the tape casting method or molecular layer deposition (MLD) technology. In some examples, the protective layer has a thickness in a range from 1 μm to 5 μm. In some examples, the protective layer comprises PVDF having a thickness in a range from 0.5 μm to 2 μm (e.g., 1 μm).

In some examples, the separator layer supports the active solid coating layer and the protective layer. Examples of the separator layer include a polyolefin-based separator layer (e.g., polyacetylene-polypropylene (PP), polyethylene (PE), dual-layer type: PP-PE, three-layer type: PP-PE-PP), a cellulose separator layer, a polyvinylidene fluoride (PVDF) layer, and a porous polyimide layer. In some examples, the separator layer has a thickness in a range from 6 μm to 25 μm.

In some examples, the cathode electrode comprises cathode active material in a range from 30 to 98 wt %, an optional conductive additive in a range from 1 to 30 wt %, and an optional binder in a range from 1 to 20 wt %. In some examples, the cathode active material is selected from a group consisting of a layered oxide (represented by the formula LiMO₂), an olivine-type oxide (represented by the formula LiMPO₄), a monoclinic-type oxide (represented by the formula Li₃M₂(PO₄)₃), a spinel-type oxide (represented by the formula LiM₂O₄), where M is a transition metal (e.g., Co, Ni, Mn, Fe, Al, V, or a combination thereof), sulfide (S), and/or lithium sulfide (Li₂S).

In some examples, the conductive additive is selected from a group consisting of carbon black, graphite, graphene, graphene oxide, Super P, acetylene black, carbon nanofibers, carbon nanotubes and other electronically conductive additives.

In some examples, the binder is selected from a group consisting of poly(vinylidene fluoride) (PVDF), poly(vinylidenefluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

In some examples, the anode electrode includes anode active material selected from a group consisting of metallic lithium or lithium metal composites. In some examples, lithium metal composites are represented by Li/Y that contain metallic lithium phase, where Y can be Ag, Sn, C, Si and so on.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
C cathode electrodes;
A anode electrodes; and
S separators, where C, A, and S are integers greater than zero,
wherein each of the S separators includes:
a separator layer;
a first active solid coating layer arranged on the separator layer; and
a protective layer.

2. The battery cell of claim 1, wherein each of the S separators further includes a second active coating layer.

3. The battery cell of claim 1, wherein:
the separator layer is arranged adjacent to one of the C cathode electrodes;
the first active solid coating layer is arranged adjacent to the separator layer; and
the protective layer is arranged between the first active solid coating layer and one of the A anode electrodes.

4. The battery cell of claim 2, wherein:
the second active coating layer is arranged adjacent to one of the C cathode electrodes;
the separator layer is arranged adjacent to the second active coating layer;
the first active solid coating layer is arranged adjacent to the separator layer; and
the protective layer is arranged between the first active solid coating layer and one of the A anode electrodes.

5. The battery cell of claim 1, wherein the first active solid coating layer comprises active solid particles that react with lithium.

6. The battery cell of claim 5, wherein the active solid particles are selected from a group consisting of Li_{1.3}Al_{0.3}Ti_{1.7}(PO₄)₃ (LATP), Li_{0.33}La_{0.56}TiO₃ (LLTO), Si, Sn, Li₂S—P₂S₅—GeS₂ system, Li_{3.25}Ge_{0.25}P_{0.75}S₄, and Li₁₀GeP₂S₁₂.

7. The battery cell of claim 6, wherein the active solid particles have a particle size in a range from 10 nm to 1000 nm.

8. The battery cell of claim 5, wherein the first active solid coating layer has a thickness in a range from 1 μm to 10 μm.

9. The battery cell of claim 1, wherein the protective layer comprises a polymer selected from a group consisting of polyvinylidene difluoride (PVDF), poly(methyl methacrylate) (PMMA), poly(ethylene oxide) (PEO).

10. The battery cell of claim 9, wherein the protective layer has a thickness in a range from 1 μm to 5 μm.

11. The battery cell of claim 1, wherein the separator layer is selected from a group consisting of a polyolefin-based separator layer, a cellulose separator layer, a polyvinylidene fluoride (PVDF) layer, and a porous polyimide layer.

12. The battery cell of claim 11, wherein the separator layer has a thickness in a range from 6 μm to 25 μm.

13. The battery cell of claim 1, wherein:
the A anode electrodes include anode active material selected from a group consisting of metallic lithium and lithium metal composites,
the C cathode electrodes comprise cathode active material in a range from 30 to 98 wt %, and
the cathode active material is selected from a group consisting of a layered oxide, an olivine-type oxide, a monoclinic-type oxide, a spinel-type oxide, sulfide (S), and lithium sulfide (Li₂S), where M is a transition metal.

14. The battery cell of claim 1, wherein the C cathode electrodes further comprise at least one of:
a conductive additive in a range from 1 to 30 wt %, wherein the conductive additive is selected from a group consisting of carbon black, graphite, graphene, graphene oxide, Super P, acetylene black, carbon nanofibers, carbon nanotubes and other electronically conductive additives; and
a binder in a range from 1 to 20 wt %, wherein the binder is selected from a group consisting of poly(vinylidene fluoride) (PVDF), poly(vinylidenefluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

15. A battery cell comprising:
C cathode electrodes;
A anode electrodes including anode active material selected from a group consisting of metallic lithium and lithium metal composites; and
S separators, where C, A, and S are integers greater than zero,
wherein each of the S separators includes:
a separator layer;
a first active solid coating layer arranged on the separator layer and including active solid particles selected from a group consisting of Li_{1.3}Al_{0.3}Ti_{1.7}(PO₄)₃ (LATP), Li_{0.33}La_{0.56}TiO₃ (LLTO), Si, Sn, Li₂S—P₂S₅—GeS₂ system, Li_{3.25}Ge_{0.25}P_{0.75}S₄ and Li₁₀GeP₂S₁₂; and
a protective layer arranged on the first active solid coating layer.

16. The battery cell of claim 15, wherein each of the S separators further includes a second active solid coating layer arranged between the separator layer and one of the C cathode electrodes.

17. The battery cell of claim 15, wherein:
the active solid particles have a particle size in a range from 10 nm to 1000 nm; and
the first active solid coating layer has a thickness in a range from 1 μm to 10 μm.

18. The battery cell of claim 15, wherein:
the protective layer comprises a polymer selected from a group consisting of polyvinylidene difluoride (PVDF), poly(methyl methacrylate) (PMMA), poly(ethylene oxide) (PEO); and
the protective layer has a thickness in a range from 1 μm to 5 μm.

19. The battery cell of claim 15, wherein:
the separator layer is selected from a group consisting of a polyolefin-based separator layer, a cellulose separator layer, a polyvinylidene fluoride (PVDF) layer, and a porous polyimide layer; and
the separator layer has a thickness in a range from 6 μm to 25 μm.

20. The battery cell of claim 15, wherein:
the C cathode electrodes comprise cathode active material in a range from 30 to 98 wt %, and
the cathode active material is selected from a group consisting of a layered oxide, an olivine-type oxide, a monoclinic-type oxide, a spinel-type oxide, sulfide (S), and lithium sulfide (Li₂S), where M is a transition metal.
